(19) United States
(12) Patent Application Publication
(10) Pub. No.: US 2013/0271354 A1
(43) Pub. Date: Oct. 17, 2013

(54) SHARED CONFIGURABLE PHYSICAL LAYER

(71) Applicants: Ramakanth Kondagunturi, Austin, TX (US); Quang T. Le, Austin, TX (US); Percy W. Wong, Austin, TX (US)

(72) Inventors: Ramakanth Kondagunturi, Austin, TX (US); Quang T. Le, Austin, TX (US); Percy W. Wong, Austin, TX (US)

(21) Appl. No.: 13/993,115

(22) PCT Filed: Sep. 30, 2011
(86) PCT No.: PCT/US11/54164

§ 371 Date: Jun. 11, 2013

(51) Int. Cl. H04L 29/10

(52) U.S. Cl. CPC H04L 29/10
USPC 345/1.2

(57) ABSTRACT

An embodiment of the invention includes a hardware architecture for, as an example, mobile computing devices. The architecture includes a physical layer that can be configured to be shared across one or more display panels that, in some instances, have different resolutions and bandwidth requirements. Using a shared physical layer removes one of the physical layers typically needed for multiple display devices (e.g., smart phones with two displays). In one embodiment, one physical layer includes two or more reference clock lanes so data lanes can be shared across two or more links The shared physical layer may be configured via a display driver. Other embodiments are described herein.

### BACKGROUND

The International Organization for Standardization Open Systems Interconnection (ISO/OSI) model is a layered architecture that standardizes levels of service and types of interaction for computers exchanging information through a communications network. The ISO/OSI model separates computer-to-computer communications into seven layers, or levels, each building upon the standards contained in the levels below it. The highest of the seven layers deals with software interactions at the application-program level. In contrast, the lowest level is the “physical layer” (PHY), which is hardware-oriented and deals with aspects of establishing and maintaining a physical link between communicating computers. Among specifications covered on the physical layer are cabling, electrical signals, and mechanical connections.

Mobile Industry Processor Interface (MIPI) is a group that sets standards for mobile computing devices. Smart phones, personal digital assistants, laptops, tablets, and, more generally, mobile computing devices, are increasingly designed with one or more MIPI configuration compliant display panels. When multiple display panels are included in a device each display may respectively have a different size and/or resolution from the other display or displays.

Each of the multiple panels may require a MIPI link (source synchronous interface). Thus, different physical layers are conventionally needed for each display. For example, clamshell displays typically require two display controllers with two separate physical layers. The physical layers respectively include different fixed bandwidths to support the different pixel streams destined for the different displays. This need for multiple physical layers for multiple displays is inefficient in terms of power, space, and cost.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes a conventional physical layer for a mobile computing device.

FIG. 2 includes a block diagram for a physical layer in an embodiment of the invention.

FIG. 3 includes a block diagram for a physical layer in an embodiment of the invention.

FIG. 4 includes a block flow diagram for a method in an embodiment of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

An embodiment of the invention includes a hardware architecture for, as an example only, mobile computing devices. The architecture includes a single physical layer that can be configured (and later reconfigured) to be shared across one or more display panels that possibly (but not necessarily) have different resolutions and/or bandwidth requirements. Using a shared physical layer removes one of the physical layers typically needed for multi display devices (e.g., smart phones). In one embodiment, one physical layer includes two or more reference clock lanes (instead of one clock lane found in some conventional configurations) so data lanes can be shared across two or more links while maintaining independent timing restraints for each of the independent displays. The shared physical layer may be configured via a display driver.

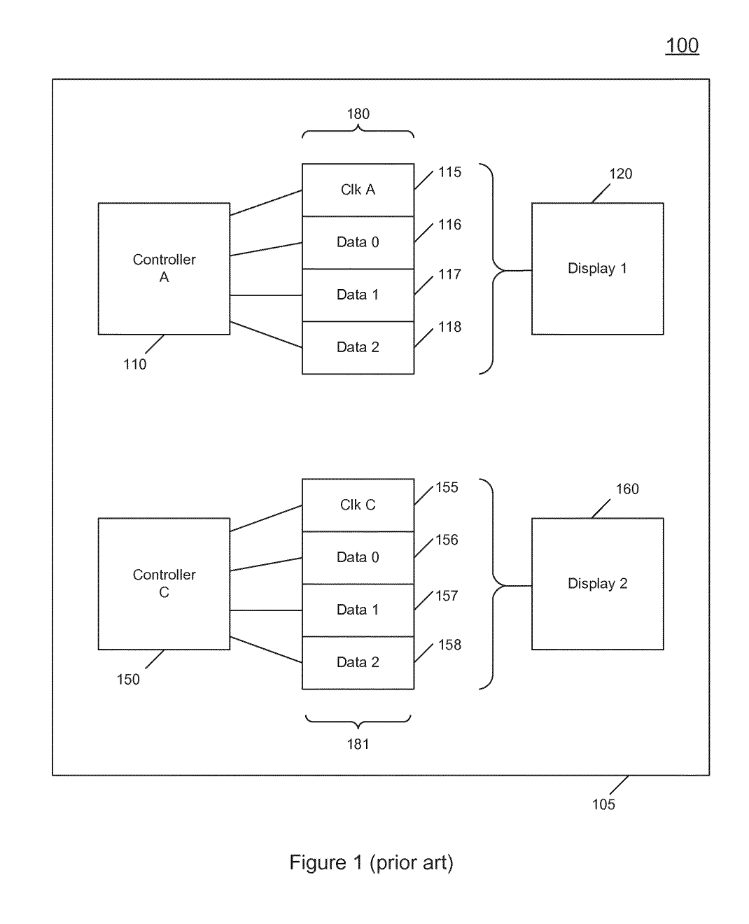

FIG. 1 includes two independent and separate conventional physical layers for a mobile computing device 105. Controller 110 drives clock lane 115 and data lanes 116, 117, 118 all to eventually drive display 120. Controller 150 drives clock lane 155 and data lanes 156, 157, 158 all to eventually drive display 160. Thus, physical layer 180 drives display 120 while physical layer 181, separate and apart from physical layer 180, drives display 160. Displays 120, 160 may be MIPI displays. Each display requires a dedicated MIPI physical link to support independent pixel streams. The requisite doubling of physical layers consumes a substantial die area.

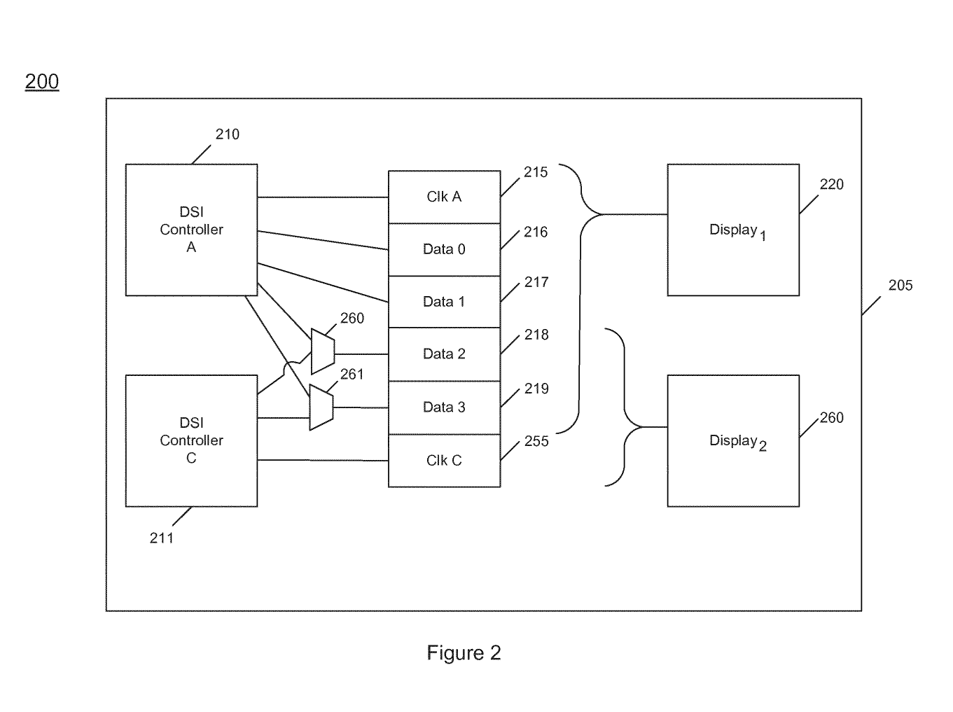

FIG. 2 includes a block diagram for a physical layer in an embodiment of the invention. Device 205 includes controllers 210 and 211 as well as displays 220 and 260. Controller 210 drives clock lane 215 and data lanes 216 and 217. Controller 211 drives clock lane 255. Multiplexors 260, 261 are programmable to share data lanes 218 and 219 between displays 220 and 260 and controllers 210, 211. This allows for various usage configurations such as: (1) all data lanes (216, 217, 218, 219) are assigned to display controller 210 for single display device using display 220, (2) data lines 216, 217, 218 can be allocated to display controller 210 and display 220 and data line 219 can be allocated to display controller 211 for display device 260 (i.e., a device with dual active displays), and (3) data lines 216, 217 can be allocated to display controller 210 and display 220 and data lines 218, 219 can be allocated to display controller 211 for display device 260 with dual independent displays.

In an embodiment, various data lanes may be bi-directional. For example, data lanes 216 and 219 may be bi-directional to provide receiving data paths in a dual mode configuration. In an embodiment, data lane 219, for example, may be uni-directional for a configuration where all data lanes (216, 217, 218, and 219) are allocated to display controller 210 for a single active display device, but bi-directional for configurations where some of the data lanes are allocated to controller 210 and others are allocated to controller 211.

In an embodiment different configurations are programmed via a display driver. This may be helpful when dual independent displays need to be dynamically reprogrammed based on new bandwidth needs for the displays (e.g., when displays are swapped out or when display content changes). The display driver may provide logic settings such as: 00 (all four lanes are configured for controller 210 (port or tube A) while any remaining lanes for controller 211 (port or tube C) are disabled); 01 (three data lanes are configured for port A/controller 210 and one data lane for port C/controller 211); 10 (each of port A and C has two data lanes); 11 (reserved). These two configuration bits may be set by logic straps in an embodiment.

FIG. 2 includes an embodiment configured for a MIPI D-PHY configuration. D-PHY is a source synchronous system requiring transmission of a clock signal along with the data. It has two modes of operation, a high speed mode and a low power mode. The high speed mode uses low swing differential signaling while the low power mode uses LVCMOS level swings. However, the embodiment in FIG. 2 is not limited to working with MIPI D-PHY compliant architectures.

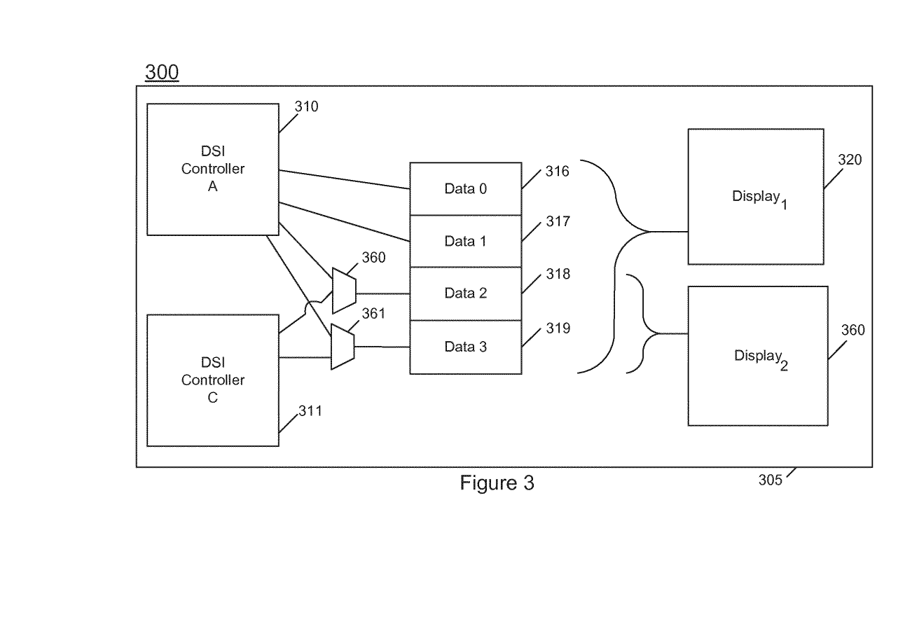

FIG. 3 includes a block diagram for a physical layer for an embodiment compliant with the MIPI M-PHY configuration. The M-PHY is an asynchronous system with the clock data embedded in the data stream itself. For example, a 3 Gbps M-PHY sub-link may require only 2 signals (1 data lane) while an equivalent D-PHY system may require four times the number of signals (3 data lanes+1 clock lane). The M-PHY protocol may allow for high data rates (e.g., 6 Gbps and beyond). However, the embodiment in FIG. 3 is not limited to working with MIPI M-PHY compliant architectures.

Specifically, FIG. 3 includes a block diagram for a physical layer in an embodiment of the invention. Device 305 includes controllers 310 and 311 as well as displays 320 and 360. Controller 310 drives data lanes 316 and 317. Multiplexors 360, 361 are programmable to share data lanes 318 and 319 between displays 320 and 360 and controllers 310, 311. This allows for various usage configurations such as: (1) all data lanes (316, 317, 318, 319) are assigned to display controller 310 for single display device (e.g., display 320), (2) data lines 316, 317, 318 can be allocated to display controller 310 and display 320 and data line 319 can be allocated to display controller 311 for display device 360 (i.e., dual independent displays), and (3) data lines 316, 317 can be allocated to display controller 310 and display 320 and data lines 318, 319 can be allocated to display controller 311 for display device 360 (i.e., dual independent displays).

Notably, embodiments of the invention can be extended for multiple displays (2, 3, 4, 5, 6 and the like) with a variety of programmable configurations.

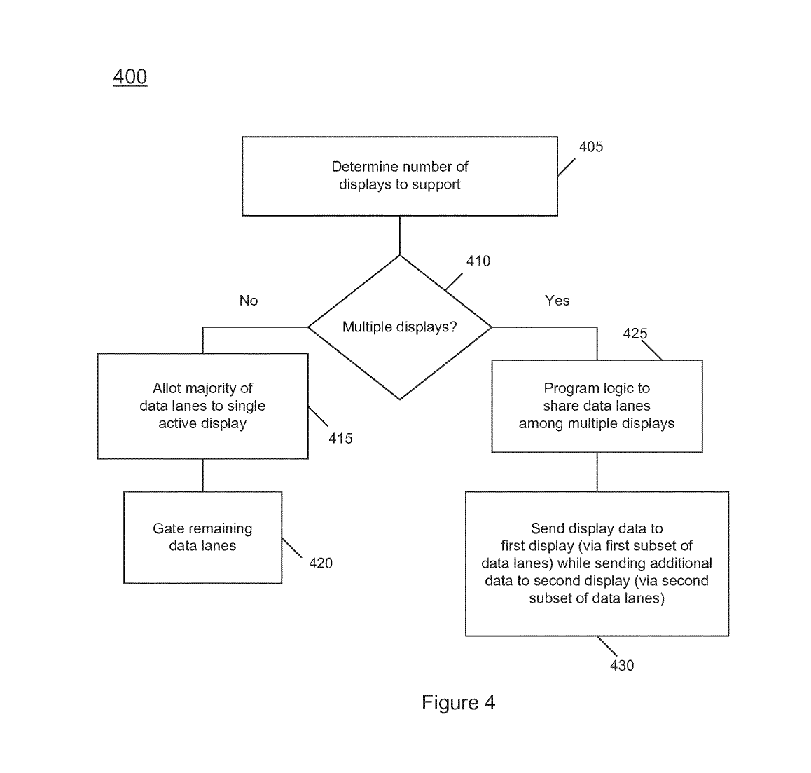

FIG. 4 includes a block flow diagram for a method in an embodiment of the invention. Blocks 405 and 410 determine whether multiple displays will need to be supported. If only a single display needs support, in block 415 (assuming a hypothetical situation where there are four data lanes, in a single physical layer, to potentially be shared) the device is configured so first, second, and third data lanes (if that is all the bandwidth needed) will simultaneously communicate with the first display. This configuration process may occur via programmable logic, such as logic associated with a multiplexor and/or other switching technologies. In block 420, any fourth or additional lane not to be allocated to the single active display may be gated to, for example, conserve power.

If, however, multiple displays will need support, in block 425 logic may be configured so, for example, first and second data lanes communicate with a first display while simultaneously a third data lane (or more) communicates with a second display. In block 430, independent data streams are sent to the displays. For example, the first display may display a graphical user interface (GUI) (e.g., email or internet browser) based on data sent via two data lanes, while the second display displays a live broadcast of a sporting event based on data sent via another two data lanes. The first display may be allocated fewer data lanes if, for example, the GUI has lower bandwidth and/or resolution needs than the second display, which shows the sporting event.

If the bandwidth and/or resolution needs ever “flip” so the first display has higher bandwidth and/or resolution needs than the other display, then the logic (e.g., multiplexor and/or display driver) can be “dynamically” reprogrammed to redistribute data lanes so more data lanes and bandwidth target the first display than the second display.

Thus, embodiments may be configurable for single or multiple display MIPI interface needs without having to create a custom die design for each different configuration. Embodiments have the flexibility to allocate a number of data lanes to a display based on bandwidth needs for the display. Embodiments may also gate unused data lanes for power savings. Furthermore, embodiments may provide die area savings as multiple display controllers and displays can share the same physical layer.

Accordingly, one embodiment includes an OSI model physical layer including first, second, and third data lanes. The single physical layer is shared among first and second displays so (a) in a first configuration the first, second, and third data lanes simultaneously communicate with the first display; and (b) in a second configuration the first and second data lanes communicate with the first display while simultaneously the third data lane communicates with the second display.

A user may dynamically reconfigure the device or system based on, for example, the first and second displays having different resolutions. With regard to FIG. 2, if display 220 has high resolution and/or higher bandwidth needs than display 260, a user may configure the data lanes so more data lanes are directed towards display 220 and fewer data lines are directed towards display 260. This configuration may occur via a device driver. In other embodiments, the configuration may occur via hardware settings and/or firmware settings. In some embodiments, discovery may occur to determine how many displays are in the device. Embodiments may further engage in discovery of the bandwidth and/or resolution requirements for the displays. Based on any of the above discoveries, an embodiment may automatically configure the physical layer division of data lanes. For example, upon discovering there are two displays to be used and the first display has greater bandwidth and/or resolution needs than the second display, an embodiment may automatically steer or dedicate more data lanes to the greater bandwidth/resolution display than the lower bandwidth/resolution display.

In one embodiment, in a configuration with shared lanes among displays a first data lane may communicate data to a first display while simultaneously a third data lane may communicate additional data, different from the data for the first display, with a second display. Thus, the embodiment does more than “split” video between two displays but instead may display two different data streams on two different displays. For example, a first image on a first display (e.g., a GUI) simultaneously with a second image on a second display (e.g., a sporting event).

An embodiment includes first and second clock lanes (e.g., in a MIPI D-PHY configuration), wherein in a configuration the first clock lane provides timing data for a first display while the second clock lane simultaneously provides additional timing data for a second display.

An embodiment includes first and second display controllers, respectively for first and second displays, and multiplexor logic. The logic is configurable (e.g., via display driver, firmware, hardware setting, etc.) to divide first, second, and third data lanes among the first and second displays based on bandwidth requirements for the first and second displays. In an embodiment, the logic is dynamically configurable to change the apparatus between the multiple configurations of lane sharing/distribution among one or more displays. By being “dynamically configurable”, embodiments do not require different dies for different configurations that vary in how data lanes are divided among different displays. Instead, “dynamic” means the configurations may be implemented (e.g., all lanes to single display), switched (e.g., some lanes to one display and other lanes to another display), and reversed (e.g., all lanes to single display) based on, for example, device drivers, firmware settings, and general hardware settings.

In an embodiment, the physical layer may include a fourth data lane. In a first configuration the fourth data lane may be unused. In such a case, the configuration may be set so the fourth lane is gated, thereby conserving power.

While embodiments have been described in coordination with various MIPI standards, other embodiments are not limited to any particular standard, MIPI or otherwise.

Embodiments may be implemented in code and may be stored on a non-transitory storage medium having stored thereon instructions which can be used to program a system to perform the instructions. The storage medium may include, but is not limited to, any type of disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions. Embodiments of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. The terms “code” or “program” cover a broad range of components and constructs, including applications, drivers, processes, routines, methods, modules, and subprograms and may refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered. Components or modules may be combined or separated as desired, and may be positioned in one or more portions of a device.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a Open Systems Interconnection (OSI) model physical layer including first, second, and third data lanes;
wherein the single physical layer is configured to be shared among first and second displays so (a) in a first configuration the first, second, and third data lanes simultaneously communicate with the first display; and (b) in a second configuration the first and second data lanes communicate with the first display while simultaneously the third data lane communicates with the second display.

2. The apparatus of claim 1, wherein the first and second displays have different resolutions.

3. The apparatus of claim 2, wherein the different resolutions require different bandwidths.

4. The apparatus of claim 1, wherein in the second configuration the first data lane communicates data for the first display while simultaneously the third data lane communicates additional data, different from the data for the first display, for the second display.

5. The apparatus of claim 1 further comprising first and second clock lanes, wherein in the second configuration the first clock lane provides timing data for the first display while the second clock lane simultaneously provides additional timing data for the second display.

6. The apparatus of claim 1 including first and second display controllers, respectively for the first and second displays, and multiplexor logic wherein the logic is configurable to divide the first, second, and third data lanes among the first and second displays.

7. The apparatus of claim 1 including first and second display controllers, respectively for the first and second displays, and multiplexor logic wherein the logic is configurable to divide the first, second, and third data lanes among the first and second displays based on bandwidth requirements for the first and second displays.

8. The apparatus of claim 7, wherein the logic is dynamically configurable to change the apparatus between the first and second configurations.

9. The apparatus of claim 1, wherein the physical layer includes a fourth data lane and in the first configuration the fourth data lane is unused and gated.

10. A system comprising:
a single physical layer including first and second data lanes;
first and second displays; and
first and second controllers;
wherein the single physical layer is shared among the first and second displays so (a) in a first configuration the first and second data lanes simultaneously communicate with the first display; and (b) in a second configuration the first data lane communicates with the first display while simultaneously the second data lane communicates with the second display.

11. The system of claim 10, wherein the first and second displays have different resolutions that respectively require different bandwidths.

12. The system of claim 10 including multiplexor logic that is configurable to divide the first and second data lanes among the first and second displays.

13. The system of claim 12, wherein the logic is dynamically configurable to change the apparatus between the first and second configurations.

14. The system of claim 10 further comprising first and second clock lanes, wherein in the second configuration the first clock lane provides timing data for the first display while the second clock lane simultaneously provides additional timing data for the second display.

15. The system of claim 10, wherein the physical layer includes a third data lane and in the first configuration the third data lane is unused and gated.

16. A method comprising:
providing a device including a physical layer including first, second, and third data lanes, the single physical layer being shared among first and second displays; and
configuring the device in one of first and second configurations;
wherein (a) in a first configuration the first, second, and third data lanes simultaneously communicate with the first display; and (b) in a second configuration the first and second data lanes communicate with the first display while simultaneously the third data lane communicates with the second display.

17. The method of claim 16, wherein the first and second displays have different resolutions that respectively require different bandwidths.

18. The method of claim 16 including dynamically reconfiguring the device from one of the first and second configurations to another of the first and second configurations.

19. The method of claim 16 wherein the device comprises first and second display controllers, respectively for the first and second displays, and multiplexor logic, the method further including configuring the logic to divide the first, second, and third data lanes among the first and second displays.

20. The method of claim 16, wherein the physical layer includes a fourth data lane, the method further including gating the fourth data lane while it is unused.
